(19) United States
(12) Patent Application Publication
(10) Pub. No.: US 2024/0196189 A1
(43) Pub. Date: Jun. 13, 2024

(54) METHODS FOR TRACKING UE LOCATION TO ENABLE ACCESS TO A NON-PUBLIC NETWORK

(71) Applicant: Cisco Technology, Inc., San Jose, CA (US)

(72) Inventors: Sri Gundavelli, San Jose, CA (US); Vimal Srivastava, Bangalore (IN); Irfan Ali, Palo Alto, CA (US)

(21) Appl. No.: 18/063,638

(22) Filed: Dec. 8, 2022

(51) Int. Cl. H04W 8/08

(52) U.S. Cl. CPC H04W 8/08

(57) ABSTRACT

Disclosed herein are systems, methods, and computer-readable media for causing an user equipment (UE) to connect to a non-public network (NPN) while meeting time and location requirements. In one aspect, a method includes receiving, by the UE and from a home public land mobile network (h-PLMN), a steering of roaming update providing a steering of roaming record. In one aspect, the UE, is configured based on the steering of roaming record, to connect to the non-public network (NPN) when a context of the UE meets time and location requirements. In one aspect, the method includes establishing, by the UE, a session with the NPN when the context of the UE meets the time and location requirements.

### FIELD OF THE INVENTION

The subject matter of this disclosure generally relates to the field of computer networking, and more particularly, enabling access for a user equipment (UE) to connect to a non-public network (NPN) while meeting time and location requirements.

### BACKGROUND

Fifth generation (5G) mobile and wireless networks will provide enhanced mobile broadband communications and are intended to deliver a wider range of services and applications as compared to all prior generation mobile and wireless networks. Compared to prior generations of mobile and wireless networks, the 5G architecture is service-based, meaning that wherever suitable, architecture elements are defined as network functions that offer their services to other network functions via common framework interfaces. To support this wide range of services and network functions across an ever-growing base of user equipment (UE), 5G networks incorporate the network slicing concept utilized in previous generation architectures.

Current mobile and wireless communication systems have widely adopted a next-generation wireless communication system, 5G, that provides much higher data rates and lower latency.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments, which are illustrated in the appended drawings. Understanding that these drawings depict exemplary embodiments of the disclosure and are not, therefore, to be considered to be limiting of its scope, the principles herein are described and explained with additional specificity and detail through the use of the accompanying drawings in which:

FIG. 1A illustrates an example cloud computing architecture in accordance with some aspects of the disclosed technology;

FIG. 1B illustrates an example fog computing architecture in accordance with some aspects of the disclosed technology;

FIG. 2A depicts an example schematic representation of a 5G network environment in which network slicing has been implemented in accordance with some aspects of the disclosed technology;

FIG. 2B illustrates an example 5G network architecture according to some aspects of the present technology;

FIG. 3 illustrates an example communication diagram for a public network integrated (PNI) non private network (NPN) (PNI-NPN) based deployment in accordance with some aspects of the disclosed technology;

FIG. 4 illustrates an example communication diagram for stand-alone non private network (SNPN) deployment in accordance with some aspects of the disclosed technology;

FIG. 5 illustrates an example communication diagram for a location based deployment accordance with some aspects of the disclosed technology;

FIG. 6 illustrates an example communication diagram for latching on to a PNI-NPN of an event in accordance with some aspects of the disclosed technology;

FIG. 7 illustrates a flowchart for causing an user equipment (UE) to connect to a non-public network (NPN) while meeting time and location requirements in accordance with some aspects of the disclosed technology;

FIG. 8 shows an example of a computing system 800, which can be, for example any computing device that can implement components of the system in accordance with some aspects of the disclosed technology; and

FIG. 9 illustrates an example network device in accordance with some aspects of the disclosed technology.

### DETAILED DESCRIPTION

Various embodiments of the disclosure are discussed in detail below. While specific implementations are discussed, it should be understood that this is done for illustration purposes. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for the convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

The present disclosure is directed toward enabling access for a user equipment (UE) to connected to a non-public network (NPN) while meeting time and location requirements.

In an example, a method can include receiving by a UE and from a home public land mobile network (h-PLMN), a steering of roaming update providing a steering of roaming record. The UE can be configured based on the steering of roaming record to connect to a non-public network (NPN) when a context of the UE meets time and location requirements. The UE can further establish a session with the NPN when the context of the UE meets the time and location requirements.

In an example, the steering of roaming update configures the UE with time specific data for the time requirements and location specific data for the location requirement. Accordingly, the UE can discover and select the NPN based on the time specific data and the location specific data.

In an example, the UE can support. dual connectivity. In some examples, after the UE has established the session with the NPN, the UE also maintains a session with the h-PLMN.

In an example, after the context of the UE no longer meets the time and location requirements, the UE can switch back to the H-PLMN, and detaching from the NPN.

In an example, the method can also include further includes receiving a non-access-stratum (NAS) message from the h-PLMN to remove the steering of roaming record related to the NPN after the time requirement has expired. In furtherance, the NAS message can be triggered by an access function of the NPN or h-PLMN or access mobility function of the h-PLMN.

In an example, the steering of roaming record is configured through coordination between the NPN and the h-PLMN. Accordingly, the method can further includes sending by a content provider and to the hPLMN, network info for the NPN for a particular subscriber of the h-PLMN, where the h-PLMN provides the SOR update to the UE.

In an example, the provider of the h-PLMN is the provider of the NPN.

In an example, the steering of roaming record includes a closed access group or network identifier associated with the location, location, or time.

In an example, the content provider is the provider of the NPN.

In an example, the method can also include receiving a request for NPN access information by the content provider, the request for the NPN access information is associated with a user acquiring access to an event at a location that is within the location requirements. The request can originate from a user associated with a subscription to access services of the h-PLMN, where the sending the network info for the NPN is responsive to receiving the request.

In an example, the method can also include, after receiving the network info for the NPN by the h-PLMN, configuring the UE to report location updates to an access function of the h-PLMN so that the access function can monitor when the UE meetings the time and location requirements for joining the NPN. The method can also include configuring the access function of the h-PLMN to register location updates of the UE. The method can also include sending a notification to the UE inviting a user associated with the UE to register for an event to gain access to the NPN. The method can also include determining that the UE has a context meeting the time and location requirements by the access function of the h-PLMN, by an access mobility function of the h-PLMN.

In an example, a device for causing a user equipment (UE) to connect to a non-public network (NPN) while meeting time and location requirements can include one or more memories having computer-readable instructions and one or more processors configured to execute the computer-readable instructions. The instructions can cause one or more processors to receive, by the UE and from a home public land mobile network (h-PLMN), a steering of roaming update providing a steering of roaming record. The UE can be configured based on the steering of roaming record, to connect to the non-public network (NPN) when a context of the UE meets time and location requirements. The instructions can cause one or more processors to establish, by the UE, a session with the NPN when the context of the UE meets the time and location requirements.

In an example, a non-transitory computer-readable storage medium having stored therein instructions which, when executed by a processor, can cause the computing system to receive, by the UE and from a home public land mobile network (h-PLMN), a steering of roaming update providing a steering of roaming record. The UE can be configured based on the steering of roaming record, to connect to the non-public network (NPN) when a context of the UE meets time and location requirements. The processor can establish, by the UE, a session with the NPN when the context of the UE meets the time and location requirements.

### Description of Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Enterprise networks can have high availability, particularly in instances when private 5G solutions are offered. For instance, the use cases can be greater than 99.99% availability including the ability to connect new IoT devices. This is particularly noteworthy for enterprise and industrial automation applications but in general applicable to various private 5G deployments.

With the new spectrum allocations for enterprise and industrial applications by the regulators, private 5G Network adoption is gaining traction. There is interest from Retailers, Enterprises and Venue operators for using Private 5G for hosting event or localized content. It is envisioned that over the next few years, there will be millions of private 5G networks (Standalone Non-Public Networks (SNPN) or Public Network Integrated Non-Public Networks (PNI-NPN) hosting various types of content, applications, and services.

The disclosed technology addresses the need in the art for method of hosting events or localized content using private 5G networks. With the new spectrum allocations for enterprise and industrial applications by the regulators on private 5G Network, it is envisioned that there will be millions of private 5G networks, such as Standalone Non-Public Networks (SNPN) or Public Network Integrated Non-Public Networks (PNI-NPN), hosting various types of content, applications, and services. Thus, subscribers of a private 5G network can benefit from on-demand, temporary and location specific access to an SNPN or PNI-NPN. For example, a subscriber after having registered for a local event should be able to activate the event-specific application and view the event without any additional configuration. In effect, an activated workflow upon the event registration, leads to the discovery of the NPN, on-boarding to the NPN, service access, and successful detachment from the NPN.

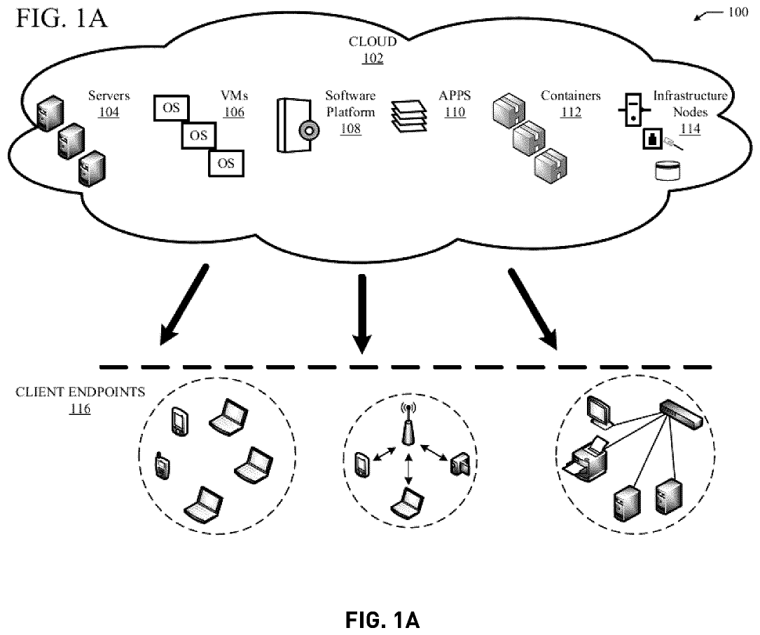

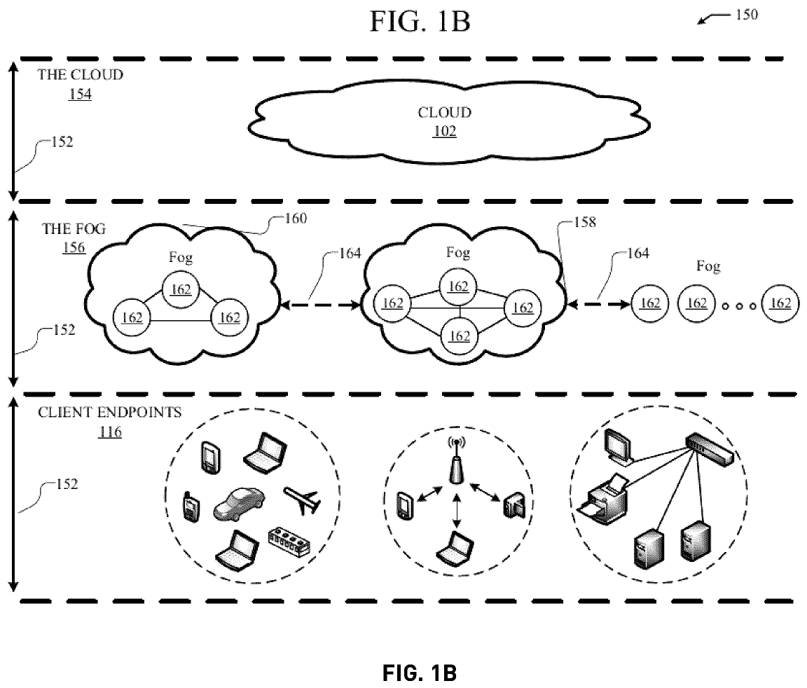

Prior to describing techniques for hosting events or localized content using private 5G networks, one or more examples of enterprise networks/cloud computing infrastructures and 5G networks will be described with reference to FIGS. 1A-B and 2A-2B.

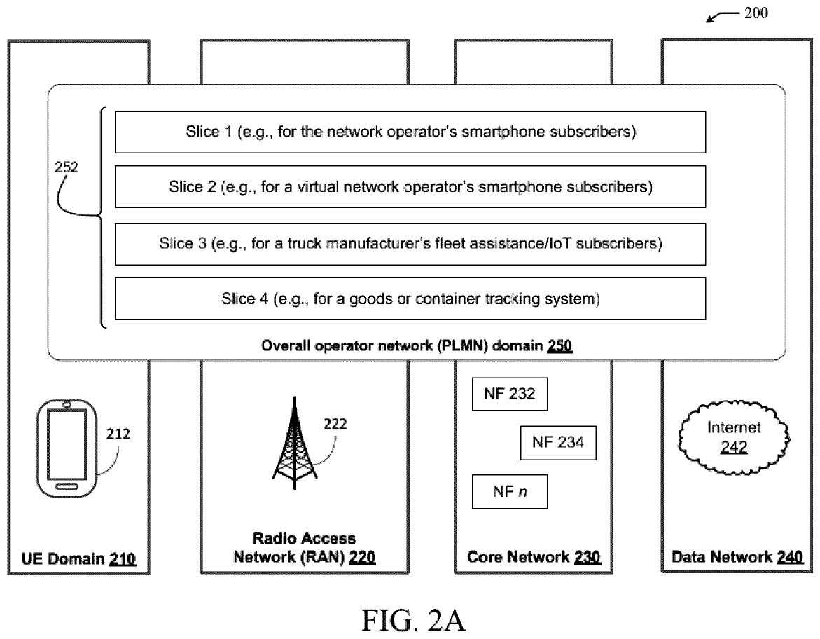

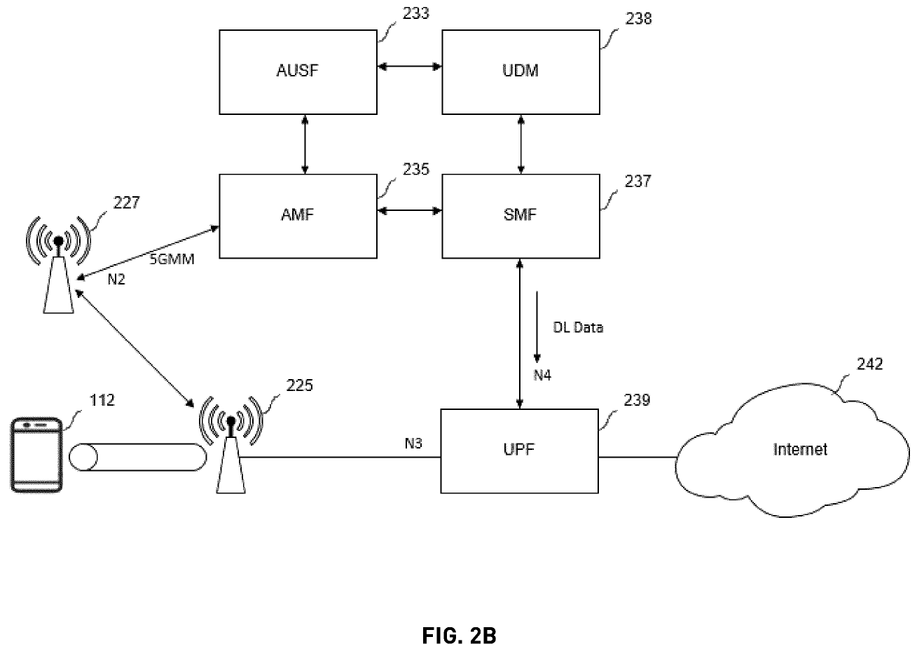

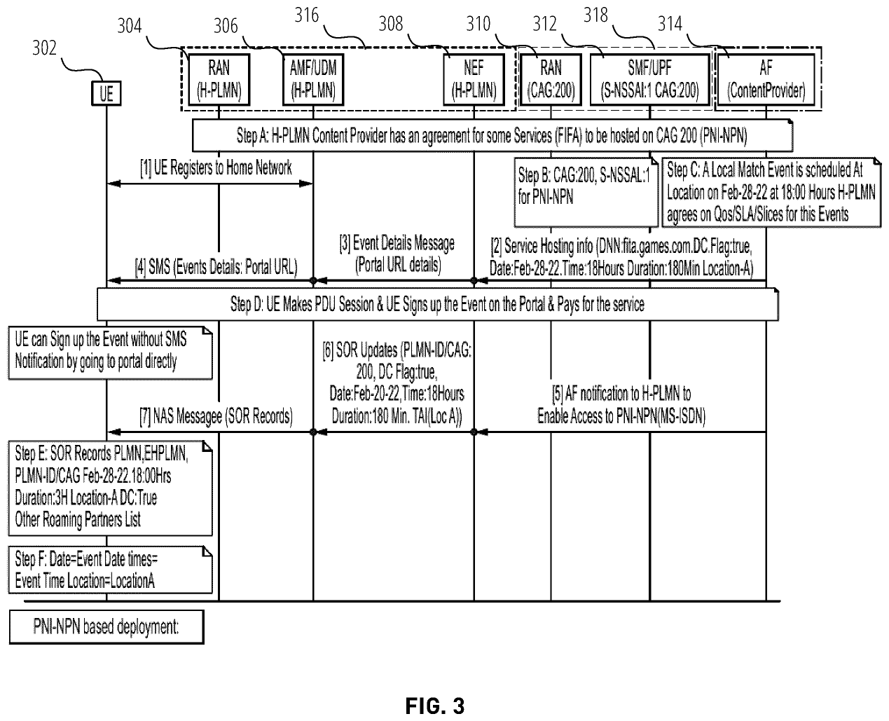

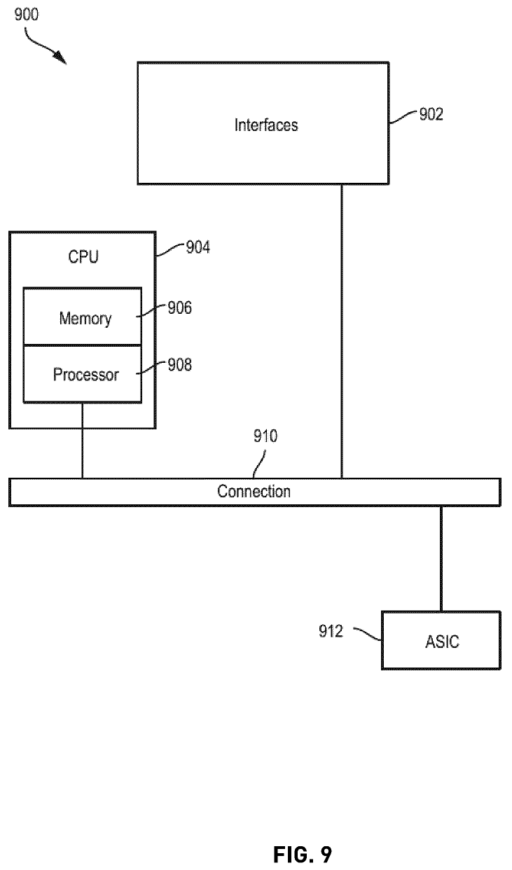

A description of network environments and architectures for network data access and services, as illustrated in FIGS. 1A, 1B, 2A and 2B is first disclosed herein. A discussion of systems, methods, and computer-readable medium for the enterprise local breakout architecture, as shown in FIGS. 3-8, will then follow. The discussion then concludes with a brief description of example devices, as illustrated in FIG. 9. These variations shall be described herein as the various embodiments are set forth. The disclosure now turns to FIG. 1A.

FIG. 1A illustrates a diagram of an example cloud computing architecture 100. The architecture can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can be used to provide various cloud computing services via the cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an Internet-of-things (IoT) device, a camera, a network printer, a transportation system (e.g., train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture 150 can be incorporated into the cloud computing architecture as described in FIG. 1A. Accordingly, the fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116, as a part of a TCP connection, accessed through the TCP connection, can include an initiator or a receiver of a TCP connection and be utilized by the initiator or the receiver to transmit and/or receive data through the TCP connection.

The fog layer 156 or “the fog” provides the computation, storage, and networking capabilities of traditional cloud networks, but closer to the endpoints. The fog can thus extend the cloud 102 to be closer to the client endpoints 116, and provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc, and be deployed within fog instances 158, 160. For example, the fog instances 156, 158 can be a regional cloud or data center, a local area network, a network of fog nodes 162, etc. Moreover, the fog nodes 162 can be deployed anywhere with a network connection, such as a factory floor, a power pole, alongside a railway track, in a vehicle, on an oil rig, in a shopping center, in a hospital, in a park, in a parking garage, in a library, etc. Moreover, one or more of the fog nodes 162 can be interconnected with each other via links 164 in various topologies, including star, ring, mesh, or hierarchical arrangements, for example.

In some cases, one or more fog nodes 162 can be mobile fog nodes. The mobile fog nodes can move to different geographic locations, logical locations, or networks, and/or fog instances while maintaining connectivity with the cloud layer 154 and/or the endpoints 116. For example, a particular fog node can be placed in a vehicle, train, which can travel from one geographic location and/or logical location to a different geographic location and/or logical location.

FIG. 2A depicts an exemplary schematic representation of a 5G network environment in which network slicing has been implemented, and in which one or more aspects of the present disclosure may operate, according to some aspects of the present disclosure. In some examples, the 5G network environment 200 can be utilized to implement the cloud 102 of FIG. 1A and/or the fog computing architecture 150 of FIG. 1B.

As illustrated, network environment 200 is divided into four domains, each of which will be explained in greater depth below; a User Equipment (UE) domain 210, e.g. of one or more enterprises, in which a plurality of user cellphones or other connected devices 212 reside; a Radio Access Network (RAN) domain 220, in which a plurality of radio cells, base stations, towers, or other radio infrastructure 222 resides; a Core Network 230, in which a plurality of Network Functions (NFs) 232, 234, . . . , n reside; and a Data Network 240, in which one or more data communication networks such as the Internet 242 reside. Additionally, the Data Network 240 can support SaaS providers configured to provide SaaSs to enterprises, e.g. to users in the UE domain 210.

In some example embodiments, core network 230 is a 5G core network (5GC) in accordance with one or more accepted 5GC architectures or designs, or an Evolved Packet Core (EPC) network, which combines aspects of the 5GC with existing 4G networks. Core Network 230 contains a plurality of Network Functions (NFs), shown here as NF 232, NF 234 . . . NF n, that executes in a control plane of core network 230. The NFs are configured to provide a service-based architecture in which a given NF allows any other authorized NFs to access its services across any of the network slices 252 or as a unique instance. The plurality of NFs of the core network 230 includes one or more of Access and Mobility Management Functions (AMF) (typically used when core network 230 is a 5GC network); Mobility Management Entities (MME) (typically used when core network 230 is an EPC network); User Plane Functions (UPFs); Policy Control Functions (PCFs); Authentication Server Functions (AUSFs); Unified Data Management functions (UDMs); Application Functions (AFs); Network Exposure Functions (NEFs); NF Repository Functions (NRFs); and Network Slice Selection Functions (NSSFs).

In some example embodiments, an AMF/MME can be common to or otherwise shared by multiple slices of the plurality of network slices 252, and in some example embodiments an AMF/MME can be unique to a single one of the plurality of network slices 252. In some examples, the NFs can include a Session Management Function (SMF) that controls session establishment, modification, release, etc., and in the course of doing so, provides other NFs with access to these constituent SMF services.

Various other NFs can be provided without departing from the scope of the present disclosure, as would be appreciated by one of ordinary skill in the art.

Across the four domains of the 5G network environment 200, an overall operator network domain 250 is defined. The operator network domain 250 is in some example embodiments a Public Land Mobile Network (PLMN), a private 5G network and/or a 5G enterprise network, and can be thought of as the carrier or business entity that provides cellular service to the end users in UE domain 210. Within the operator network domain 250, a plurality of network slices 252 are created, defined, or otherwise provisioned in order to deliver a desired set of defined features and functionalities, e.g. SaaSs, for a certain use case or corresponding to other requirements or specifications. Note that network slicing for the plurality of network slices 252 is implemented in end-to-end fashion, spanning multiple disparate technical and administrative domains, including management and orchestration planes (not shown). In other words, network slicing is performed from at least the enterprise or subscriber edge at UE domain 210, through the Radio Access Network (RAN) 120, through the 5G access edge and the 5G core network 230, and to the data network 240. Moreover, note that this network slicing may span multiple different 5G providers.

Within the scope of the 5G mobile and wireless network architecture, a network slice comprises a set of defined features and functionalities that together form a complete Public Land Mobile Network (PLMN), a private 5G network, and/or a 5G enterprise network for providing services to UEs. This network slicing permits the controlled composition of the 5G network with the specific network functions and provided services that can be provided for a specific usage scenario. In other words, network slicing enables a 5G network operator to deploy multiple, independent 5G networks where each is customized by instantiating those features, capabilities, and services to satisfy a given subset of the UEs or related business customer needs.

For example, as shown here, the plurality of network slices 252 includes Slice 1, which corresponds to smartphone subscribers of the 5G provider who also operates the network domain, and Slice 2, which corresponds to smartphone subscribers of a virtual 5G provider leasing capacity from the actual operator of network domain 250. Also shown is Slice 3, which can be provided for a fleet of connected vehicles, and Slice 4, which can be provided for an IoT goods or container tracking system across a factory network or supply chain. Note that these network slices 252 are provided for purposes of illustration, and in accordance with the present disclosure, and the operator network domain 250 can implement any number of network slices as needed, and can implement these network slices for purposes, use cases, or subsets of users and user equipment in addition to those listed above. Specifically, the operator network domain 250 can implement any number of network slices for provisioning SaaSs from SaaS providers to one or more enterprises to facilitate efficient management of SaaS provisioning to the enterprises.

FIG. 2B illustrates an example 5G network architecture. As addressed above, a User Equipment (UE) 212 can connect to a radio access network provided by a first gNodeB (gNB) 225 or a second gNB 227.

The gNB 225 can communicate over a control plane N2 interface with an access mobility function (AMF) 235. AMF 235 can handle tasks related to network access through communication with a unified data management (UDM) function 238. Collectively AMF 235 and UDM 238 can determine whether a UE should have access and if any parameters related to the access should be applied. Accordingly, the AMF 235 utilizes the UDM 238 to retrieve any access based information or restrictions of the UE 212. AMF 235 also works with AUSF 233 to handle authentication and re-authentication of the UE 212 as it moves between access networks. The AUSF and the AMF could be separated or co-located.

Assuming AMF 235 determines the UE 212 should have access to a user plane to provide voice or data communications, AMF 235 can select one or more service management functions (SMF) 237. SMF 237 can configure and control one or more user plane functions (UPF) 239. AUSF 233 can provide a security key to SMF 237 for use in encrypting control plane communications between the SMF 237 and the gNB 225 (or 227), via the UPF. For example, the SMF 237 can configure UPF 239, acting as a router, with traffic classification rules and traffic policies for the IP address.

As noted above SMF 237 can configure and control one or more user plane functions (UPF) 239. SMF 237 communicates with UPF 239 over an N4 Interface which is a bridge between the control plane and the user plane. SMF 237 can send PDU session management and traffic steering and policy rules to UPF 239 over the N4 interface. UPF 239 can send PDU usage and event reporting to SMF 237 over the N4 interface, and also communicate user plane data or voice over the N3 interface back to UE 212 through gNB 225.

FIG. 3-FIG. 5 illustrates examples of various deployment methods to provide details of a local network, such a private network hosting a localized service, to a UE. In these examples, the UE may subscribe to an event to obtain access to an event that is hosted by the private network, where the private network is discovered based on the event registration.

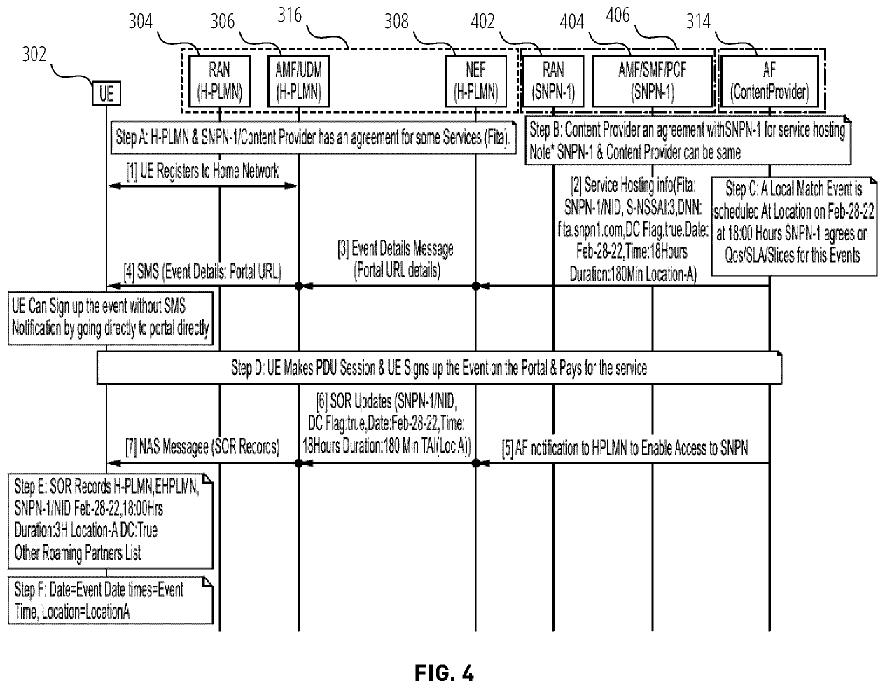

FIG. 3 and FIG. 4 illustrates an example communication diagram for a public network integrated (PNI) non public network (NPN) (PNI-NPN) based deployment in accordance with some aspects of the disclosed technology. In an example, in an instance where AMF 235 and UDM 238 has determined that the UE should have access to a NPN, the UE can be enabled with access to the NPN based on the UE's previous registration to an event supported by the NPN, as shown in FIG. 3.

In order to enable access of a UE 302 to an NPN, the UE 302, in communication [1], first registers to a home network, such as a home public land mobile network (h-PLMN) 316. The h-PLMN 316 includes a RAN 304, a AMF/UDM 306, and an NEF 308, which identifies the PLMN (Public Land Mobile Network) in which the UE's subscriber profile is held. Accordingly, as the subscriber roams to other networks, such as the NPN, the UE 302 will receive subscription information from the h-PLMN 316. In order to facilitate the receipt of the subscription information from the h-PLMN 316, the h-PLMN 316 is first associated with an agreement for network based services to be hosted on a PNI-NPN, such as a Closed Access Group (CAG) 318 or a standalone NPN (SNPN 406), as shown in Step A. The Closed Access Group (CAG) 318 or a standalone NPN (SNPN 406) is associated with a network slice identifier of the PNI-NPN, that is identified by a RAN of the CAG 310 or a RAN of the SNPN 402, and the SMF/UPF of the CAG 312 or an AMF/SMF/PCF of the SNPN 404. In Step B, the slices of the PNI-NPN are associated with an event that is scheduled by the AF of the content provider 314. Accordingly, the AF of the content provider 314 defines a plurality of service hosting information related to the event, including a time and a location.

Referring to communication [2], the AF of the content provider 314 transmits the service hosting information to the NEF of the h-PLMN 308. In communication [3], the NEF of the h-PLMN 308 generates an event details message, that includes portal URL details that are sent to the AMF/UDM of the h-PLMN 306. Upon receipt of the message, the AMF/UDM of the h-PLMN 306 can then send the event details, along with the portal URL to the UE via a message, such as an SMS, as in communication [4]. In Step D, in correspondence with communication [4], based on the event details received, the UE 302 is able to establish a PDU session, and register for the event via the URL. The URL can include a private portal for the event that allows a subscriber to subscribe to the event via a portal, associate a device with the event, and provide payment information. Alternatively, the UE can also register for the event without the receiving an SMS message, by accessing the URL, or the portal without receiving a notification.

Referring to communication [5], the AF of the content provider 314 can enable access for the UE 302 to the PNI-NPN and subsequently notify the h-PLMN 316 of the access provided to the UE 302. In step 6, the NEF of the h-PLMN 308, upon receiving an indication from the AF of the content provider 314 that access has been enabled, can generate a steering of roaming (SOR) update that is sent to the AMF/UDM of the h-PLMN 306. In step 7, the AMF/UDM of the h-PLMN 306 generates a NAS message, including the SOR update as a SOR record, that is sent to the UE 302. The UE 302, upon receipt of the SOR update, records the access details that is associated with the UE's subscription to the event, in a private network list stored in a memory of the UE. The SOR update can include access details for the UE's subscription to the PNI-NPN. As shown in Step E, the access details can include a PLMN identification, as well as a date, a time, and a duration that access to the PNI-NPN. In step F, even specific information can also be included in the NAS message. The event specific information can include the date of the event, the time of the vent, and the location of the event.

FIG. 4 illustrates an example communication diagram for a stand-alone non private network (SNPN) deployment in accordance with some aspects of the disclosed technology. FIG. 4 discussed above with the discussion of FIG. 3, can be implemented as an additional deployment method to provide details of a local network to a UE 302. Although the communication diagrams of FIG. 3 and FIG. 4 depicts a particular sequence of operations, the sequence may be altered without departing from the scope of the present disclosure. For example, some of the operations depicted in FIG. 3 may be performed in parallel or in a different sequence that does not materially affect the function of FIG. 4. In other examples, different components of an example device or system that implements the method of FIG. 4 may perform functions at the same time or in a specific sequence as FIG. 3.

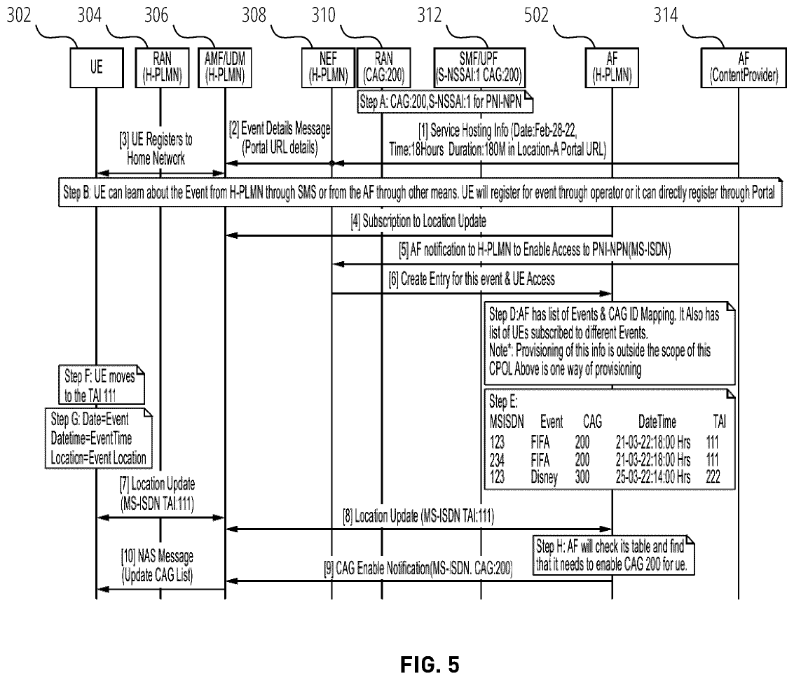

FIG. 5 illustrates an example communication diagram for a location based deployment in accordance with some aspects of the disclosed technology. For example, a location based deployment can be initiated based on the tracking of the UE's 302 current location, such as the UE's tracking area identity (TAI). Accordingly, access to a private network such as the CAG 318 or the SNPN 406, can be auto enabled for the UE 302 in the instance where the UE's 302 current location satisfies an event registration location requirement. Further reference to this deployment is made in the following steps, where a content provider and an operator will have a prior agreement about hosting an event on a PNI-NPN on a certain CAG 318 or SNPN 406, representative of step A of FIG. 5.

With regards to communication [1] an AF of the h-PLMN 502 can share service hosting information for the event to the NEF of the h-PLMN 308. In communication [2], the service hosting information is transmitted in an event details message from the PNI-NPN to the AMF/UDM of the h-PLMN 306. The service hosting information can include the date, time, duration and location of the event. Subsequently, in communication [3], the UE can register for an event through an operator or directly through a portal that is associated with the event. Alternatively, as represented by Step B, the UE can also learn about the event from the h-PLMN 316 through an SMS or from AF of the h-PLMN 502. The UE 302 can then register for the event through the operator of the event or directly through an portal associated with the event. After the UE registers for the event, in communication [4], the AF of the h-PLMN 502 subscribes to location updates of the UE, with the AMF/UDM of the h-PLMN 306. In communication [5], AF of the content provider 314 can send a notification to the NEF of the h-PLMN 308, enabling access to the PNI/NPN. This results in the NEF of the h-PLMN 308 creating an entry for the event and the UE's access to the PNI-NPN, as shown in communication [6]. Accordingly, in step D and E, in some examples, the AF of the h-PLMN 502 may have a list of events and CAG mapping identifications (IDs), as well as a list of UEs that are subscribed to a plurality of events hosted by the CAG.

In communication [7], the UE can periodically or continuously share its current location or a TAI with the AMF/UDM of the h-PLMN 306. In communication [8], the AMF/UDM of the h-PLMN 306 is configured to transmit the UE's location or TAI to the AF of the h-PLMN 502. Accordingly, the AF of the h-PLMN 502 can continuously monitor and track the location of the UE while receiving location updates for the UE from the AMF/UDM of the h-PLMN 306. Upon the receipt of location updates from the AMF/UDM of the h-PLMN 306, the AF of the h-PLMN 502 can routinely check its entry tables to determine if the UE's 302 current location is in the event location at a designated date and time as specified by the service hosting information of the CAG. In communication [9], if it is determined that the location and the date and time of the UEs 302 location coincide with the service hosting information of the CAG, a CAG notification is enabled and sent to the AMF/UDM of the h-PLMN 306. In communication [10], the AMF/UDM of the h-PLMN 306, generates and transmits a NAS message to the UE 302 that includes an updated CAG list the UE 302 has been enabled access.

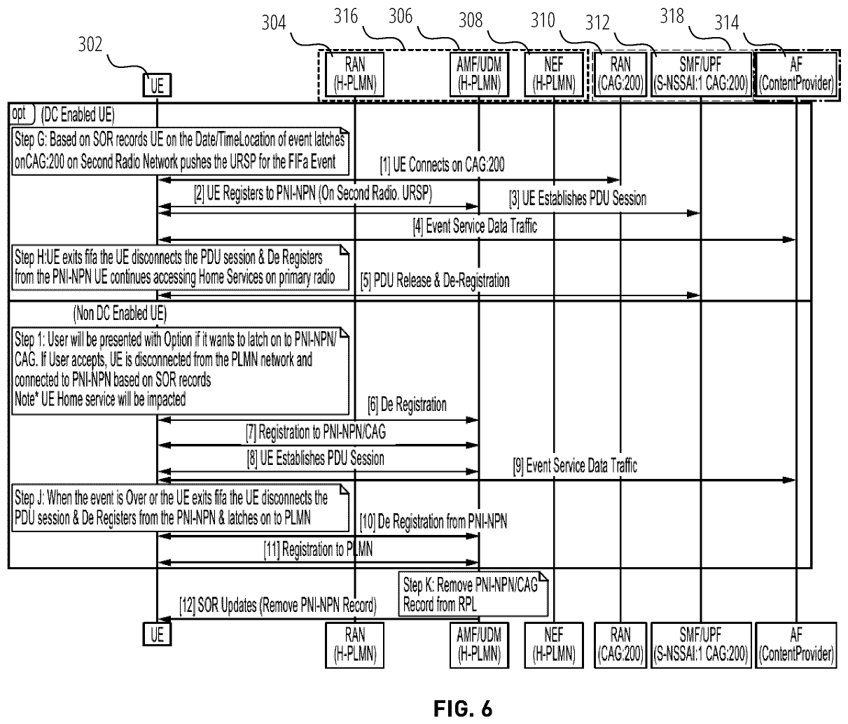

FIG. 6 illustrates an example communication diagram for latching on to a PNI-NPN of an event in accordance with some aspects of the disclosed technology. FIG. 6 can be incorporated after each deployment, or a combination thereof as described with respect to FIG. 3-FIG. 5. FIG. 6 describes, in the following steps, a process of the UE 302, enabled for dual connectivity (DC) and non-DC, latching on to the PNI-NPN, from the h-PLMN after being enabled access to the PNI-NPN.

With reference to a UE that is enabled for DC, in communication [1], of FIG. 6, the UE is enabled to connect to the RAN of the CAG 310 or RAN of the SNPN 402. In accordance with step G, this enabled connection can be based on the SOR records of the UE 302, indicating that the UE 302 is able to access the PNI-NPN at a specified date, time and location. In communication [2], the UE 302 can register to the PNI-NPN, and subsequently, in communication [3], establish a PDU session and start accessing the service being hosted by the PNI-NPN on a secondary radio node. Accordingly, in communication [4], the AF of the h-PLMN 502, is configured to communicate event service data traffic related o the PNI-NPN to the UE. In Step H, the UE can disconnect the PDU session and de-register from the PNI-NPN, allowing a continuation of access to the home services on the primary radio. Thus, in communication [5], the PDU releases the UE and permits the deregistration of the UE.

In Step I, with reference to a UE 302 that is not enabled for DC, the user of the UE 302 will be presented with an option of whether to latch the UE 302 on to the PNI-NPN. In the event that the user accepts, the UE 302 is disconnected from the h-PLMN 316, and connected to the NPI-NPN, of which can be a CAG 318 or the SNPN 406, based on SOR records. Accordingly, in communication [6], the UE 302 communicates with the AMF/UDM of the h-PLMN 306 to first deregister from the h-PLMN 316, and subsequently, in communication [7], register with the PNI-NPN. In communication [8], the UE can then establish a PDU session and start accessing service provided by the PNI-NPN. In communication [9], the AF of the content provider 314 is then permitted to provide event service traffic data to the UE 302.

Once the event ends, as depicted in Step J, the UE 302 can disconnect from the PDU session, and deregister from the PNI-NPN, depicted as the CAG 318, and latch back on to the h-PLMN 316. Accordingly, in communication [10]17, the UE 302 will submit a deregistration request from the PNI-NPN to the AMF/UDM of the h-PLMN 306. In communication [11], the AMF/UDM of the h-PLMN 306, in communication with the UE 302, assists the UE with registering and latching back on to the h-PLMN 316. In communication [12], the AMF/UDM of the h-PLMN 306 can remove the CAG 318 or SNPN 406 associated with the event from the UE through NAS signaling. In some examples, in Step K, the removal of the CAG 318 or the SNPN 406 can be initiated by a trigger received from the AF of the h-PLMN 502.

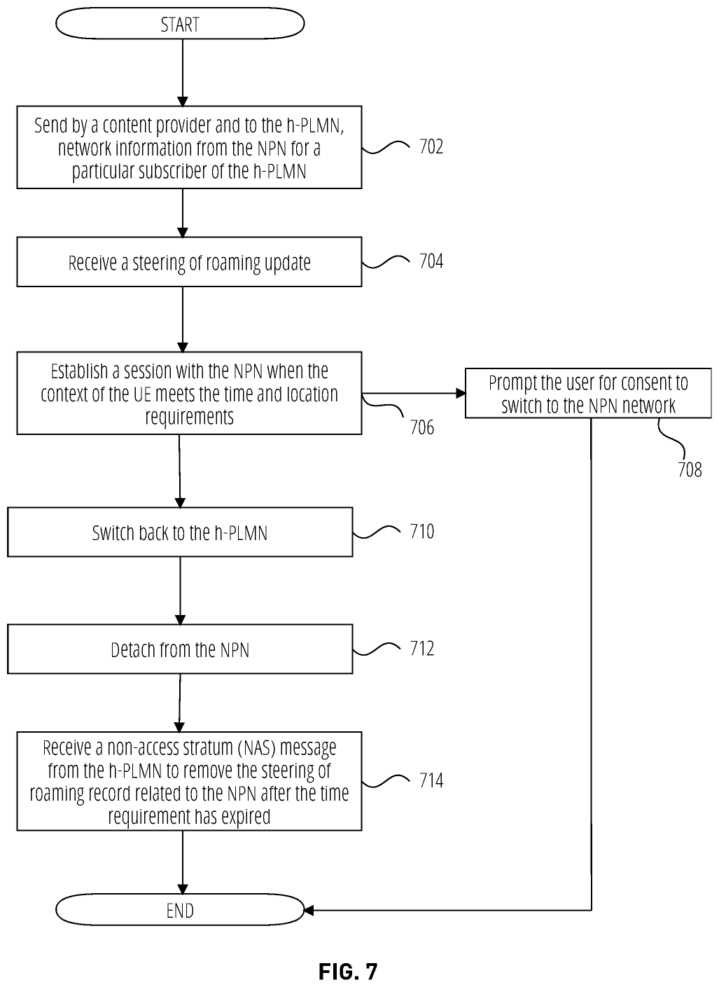

FIG. 7 illustrates an example method 700 for causing an user equipment (UE) to connect to a non-public network (NPN) while meeting time and location requirements in accordance with some aspects of the disclosed technology. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at the same time or in a specific sequence.

According to some examples, the method includes sending by a content provider and to the hPLMN, network info for the NPN for a particular subscriber of the h-PLMN at block 702. For example, the content provide AF 314 illustrated in FIG. 3 may send to the hPLMN, network info for the NPN for a particular subscriber of the h-PLMN. The h-PLMN provides the SOR update to the UE. The steering of roaming record is configured through coordination between the NPN and the h-PLMN. The content provider is the provider of the NPN. The provider of the h-PLMN is the provider of the NPN.

According to some examples, the method includes receiving a steering of roaming update at block 704. For example, the AMF/UDM of the h-PLMN 306 illustrated in FIG. 3 may receive a steering of roaming update. The UE can discover and select the NPN based on the time specific data and the location specific data. The UE is configured based on the steering of roaming record to connect to the non-public network (NPN) when a context of the UE meets time and location requirements. The steering of roaming record includes a closed access group or network identifier associated with the location, location, or time.

According to some examples, the steering of roaming update includes a steering of roaming record. In some examples, the steering of roaming record is configured through coordination between the NPN and the h-PLMN. Accordingly, the content provider can send to the h-PLMN network information for the NPN for a particular subscriber of the h-PLMN. The content provider can receive a request for NPN access information. The request for NPN access information can be associated with a user acquiring access to an event at a location that is within the location requirements. The request can originate from a user associated with a subscription to access services of the h-PLMN, where the sending of the network info for the NPN is responsive to receiving the request.

The method further comprises configuring the UE to report location updates to an access function of the h-PLMN so that the access function can monitor when the UE meets the time and location requirements for joining the NPN after receiving the network info for the NPN by the h-PLMN. The method can further comprise configuring the access function of the h-PLMN to register location updates of the UE. The h-PLMN can then send a notification to the UE inviting a user associated with the UE to register for the event to gain access to the NPN. The method can further comprise determining that the UE has a context meeting the time and location requirements by the access function of the h-PLMN. The access mobility function of the h-PLMN can then send the steering of roaming update to the UE.

According to some examples, the method includes establishing a session with the NPN when the context of the UE meets the time and location requirements at block 706. For example, the UE 302 illustrated in FIG. 6 may establish a session with the NPN when the context of the UE meets the time and location requirements.

In some embodiments, the UE supports dual connectivity. Dual connectivity means the UE can support two connections to the network simultaneously, e.g. one connection for voice and one connection for data. When the UE supports dual connectivity, the method comprises maintaining a session with the h-PLMN 316 after the UE has established a session with the NPN. For example, the UE 302 illustrated in FIG. 6 may establish a session with the NPN automatically when the context of the UE 302 meets the time and location requirements.

According to some examples, the method includes switching back to the H-PLMN at block 710. For example, after the context of UE 302 illustrated in FIG. 6 no longer meets the time and location requirements, the UE 302 may switch back to the H-PLMN.

According to some examples, the method includes detaching from the NPN at block 712. For example, the UE 302 illustrated in FIG. 6 may detach from the NPN after the context of the UE no longer meets the time and location requirements of the NPN.

According to some examples, the method includes receiving a non-access-stratum (NAS) message from the h-PLMN to remove the steering of roaming record related to NPN after the time requirement has expired at block 714. For example, the UE 302 illustrated in FIG. 6 may receive a non-access-stratum (NAS) message from the h-PLMN to remove the steering of roaming record related to NPN after the time requirement has expired. The NAS message is triggered by an access function of the NPN or h-PLMN or access mobility function of the h-PLMN.

According to some examples, the method includes prompting the user for consent to switch to the NPN network at block 708. For example, the AMF/UDM of the h-PLMN 306 illustrated in FIG. 6 may prompt the user for consent to switch to the NPN network. The prompting occurs before detaching from the h-PLMN and establishing the session with the NPN.

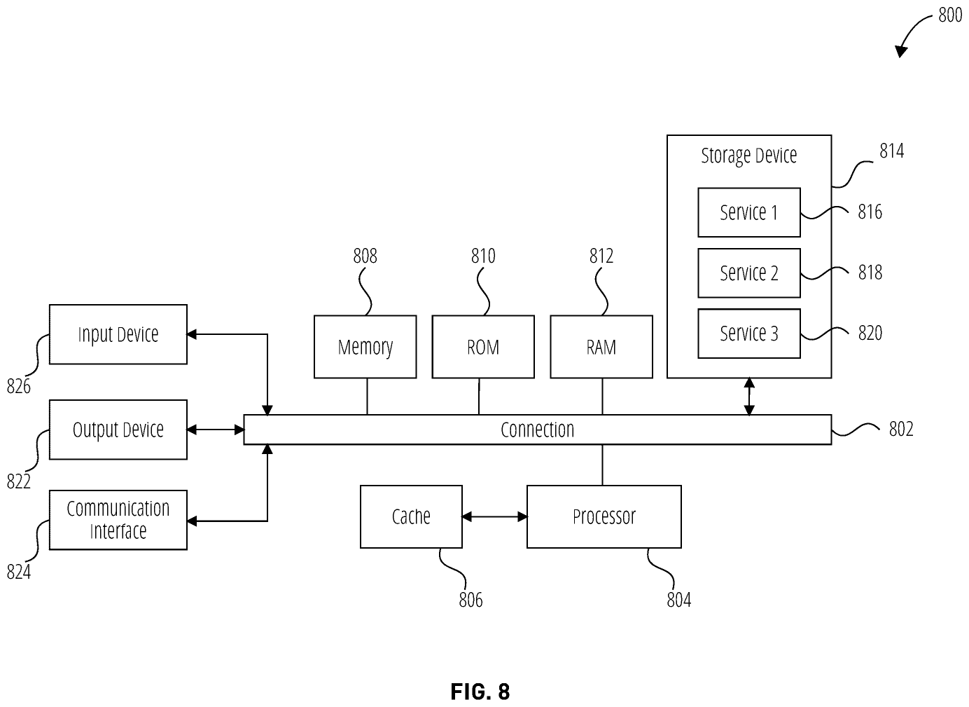

FIG. 8 shows an example of computing system 800, which can be for example any computing device making up client endpoints 116 or virtual machines 106 or UEs 302, or any component thereof in which the components of the system are in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804.

Processor 804 can include any general purpose processor and a hardware service or software service, such as services 816, 818, and 820 stored in storage device 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with hardware components, such as processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

FIG. 9 illustrates an example network device 900 suitable for performing switching, routing, load balancing, and other networking operations. The example network device 900 can be implemented as switches, routers, nodes, metadata servers, load balancers, client devices, and so forth.

Network device 900 includes a central processing unit (CPU) 904, interfaces 902, and a bus 910 (e.g., a PCI bus). When acting under the control of appropriate software or firmware, the CPU 904 is responsible for executing packet management, error detection, and/or routing functions. The CPU 904 preferably accomplishes all these functions under the control of software including an operating system and any appropriate applications software. CPU 904 may include one or more processors 908, such as a processor from the INTEL X86 family of microprocessors. In some cases, processor 908 can be specially designed hardware for controlling the operations of network device 900. In some cases, a memory 906 (e.g., non-volatile RAM, ROM, etc.) also forms part of CPU 904. However, there are many different ways in which memory could be coupled to the system.

The interfaces 902 are typically provided as modular interface cards (sometimes referred to as “line cards”). Generally, they control the sending and receiving of data packets over the network and sometimes support other peripherals used with the network device 900. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LORA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 904) to efficiently perform routing computations, network diagnostics, security functions, etc.

Although the system shown in FIG. 9 is one specific network device of the present disclosure, it is by no means the network device architecture on which the present disclosure can be implemented. For example, an architecture having a single processor that handles communications as well as routing computations, etc., is often used. Further, other types of interfaces and media could also be used with the network device 900.

Regardless of the network device's configuration, it may employ one or more memories or memory modules (including memory 906) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 906 could also hold various software containers and virtualized execution environments and data.

The network device 900 can also include an application-specific integrated circuit (ASIC), which can be configured to perform routing and/or switching operations. The ASIC can communicate with other components in the network device 900 via the bus 910, to exchange data and signals and coordinate various types of operations by the network device 900, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.
Aspect 1. A method for causing an user equipment (UE) to connect to a non-public network (NPN) while meeting time and location requirements, the method comprising: by the UE and from a home public land mobile network (h-PLMN); wherein the UE is configured based on the steering of roaming record to connect to the non-public network (NPN) when a context of the UE meets time and location requirements; and establishing a session with the NPN when the context of the UE meets the time and location requirements.
Aspect 2. The method of Aspect 1, wherein, the steering of roaming update configures the UE with time specific data for the time requirements and location specific data for the location requirement, wherein the UE can discover and select the NPN based on the time specific data and the location specific data.
Aspect 3. The method of any of Aspects 1 to 2, wherein the UE is supports dual connectivity, wherein after the US has established a session the NPN, the UE also maintains a session with the h-PLMN, wherein dual connectivity means the UE can support two connections to the network simultaneously, e.g. one connection for voice and one connection for data.
Aspect 4. The method of any of Aspects 1 to 3, wherein the establishing the session with the NPN by the UE occurs automatically when the context of the UE meets the time and location requirements.
Aspect 5. The method of any of Aspects 1 to 4, wherein the UE lacks support for dual connectivity, further comprising: before detaching from the h-PLMN and establishing the session with the NPN.
Aspect 6. The method of any of Aspects 1 to 5, further comprising: after the context of the UE no longer meets the time and location requirements, switching back to the H-PLMN; and detaching from the NPN.
Aspect 7. The method of any of Aspects 1 to 6, further comprising: receiving a non-access-stratum (NAS) message from the h-PLMN to remove the steering of roaming record related to NPN after the time requirement has expired, wherein the NAS message is triggered by an access function of the NPN or h-PLMN or access mobility function of the h-PLMN.
Aspect 8. The method of any of Aspects 1 to 7, wherein the steering of roaming record is configured through coordination between the NPN and the h-PLMN, the method further comprising: sending by a content provider and to the hPLMN, network info for the NPN for a particular subscriber of the h-PLMN; wherein the h-PLMN provides the SOR update to the UE.
Aspect 9. The method of any of Aspects 1 to 8, wherein the content provider is the provider of the NPN.
Aspect 10. The method of any of Aspects 1 to 9 [1036280], further comprising: receiving a request for NPN access information by the content provider, the request for NPN access information is associated with a user acquiring access to an event at a location that is within the location requirements, the request originating from a user associated with a subscription to access services of the h-PLMN, wherein the sending the network info for the NPN is responsive to receiving the request.
Aspect 11. The method of any of Aspects 1 to 10 [1036389], further comprising: after receiving the network info for the NPN by the h-PLMN, configuring the UE to report location updates to an access function of the h-PLMN so that the access function can monitor when the UE meetings the time and location requirements for joining the NPN; configuring the access function of the h-PLMN to register location updates of the UE; sending a notification to the UE inviting a user associated with the UE to register for the event to gain access to the NPN; determining that the UE has a context meeting the time and location requirements by the access function of the h-PLMN; by an access mobility function of the h-PLMN.
Aspect 12. The method of any of Aspects 1 to 11, wherein the provider of the h-PLMN is the provider of the NPN.
Aspect 13. The method of any of Aspects 1 to 12, wherein the steering of roaming record includes a closed access group or network identifier associated with the location, location, or time.

What is claimed is:

1. A method comprising:
receiving by a UE and from a home public land mobile network (h-PLMN), a steering of roaming update providing a steering of roaming record, wherein the UE is configured based on the steering of roaming record to connect to a non-public network (NPN) when a context of the UE meets time and location requirements; and
establishing a session with the NPN when the context of the UE meets the time and location requirements.

2. The method of claim 1, wherein, the steering of roaming update configures the UE with time specific data for the time requirements and location specific data for the location requirement, wherein the UE can discover and select the NPN based on the time specific data and the location specific data.

3. The method of claim 1, wherein the UE is supports dual connectivity, wherein after the UE has established the session with the NPN, the UE also maintains a session with the h-PLMN.

4. The method of claim 1, further comprising:
after the context of the UE no longer meets the time and location requirements, switching back to the H-PLMN; and
detaching from the NPN.

5. The method of claim 1, further comprising:
receiving a non-access-stratum (NAS) message from the h-PLMN to remove the steering of roaming record related to the NPN after the time requirement has expired, wherein the NAS message is triggered by an access function of the NPN or h-PLMN or access mobility function of the h-PLMN.

6. The method of claim 1, wherein the steering of roaming record is configured through coordination between the NPN and the h-PLMN, the method further comprising:
sending by a content provider and to the h-PLMN, network info for the NPN for a particular subscriber of the h-PLMN;
wherein the h-PLMN provides the SOR update to the UE.

7. The method of claim 6, wherein the content provider is the provider of the NPN.

8. The method of claim 6, further comprising:
receiving a request for NPN access information by the content provider, the request for the NPN access information is associated with a user acquiring access to an event at a location that is within the location requirements, the request originating from a user associated with a subscription to access services of the h-PLMN, wherein the sending the network info for the NPN is responsive to receiving the request.

9. The method of claim 6, further comprising:
after receiving the network info for the NPN by the h-PLMN, configuring the UE to report location updates to an access function of the h-PLMN so that the access function can monitor when the UE meets the time and location requirements for joining the NPN;
configuring the access function of the h-PLMN to register location updates of the UE;
sending a notification to the UE inviting a user associated with the UE to register for an event to gain access to the NPN;
determining that the UE has a context meeting the time and location requirements by the access function of the h-PLMN;
by an access mobility function of the h-PLMN.

10. The method of claim 1, wherein the provider of the h-PLMN is the provider of the NPN.

11. The method of claim 1, wherein the steering of roaming record includes a closed access group or network identifier associated with the location, location, or time.

12. A computing system comprising:
a processor; and
a memory storing instructions that, when executed by the processor, configure the system to:
receive by a UE and from a home public land mobile network (h-PLMN), a steering of roaming update providing a steering of roaming record, wherein the UE is configured based on the steering of roaming record to connect to a non-public network (NPN) when a context of the UE meets time and location requirements; and
establish a session with the NPN when the context of the UE meets the time and location requirements.

13. The computing system of claim 12, wherein, the steering of roaming update configures the UE with time specific data for the time requirements and location specific data for the location requirement, wherein the UE can discover and select the NPN based on the time specific data and the location specific data.

14. The computing system of claim 12, wherein the instructions further configure the system to:
switch back to the H-PLMN after the context of the UE no longer meets the time and location requirements; and
detach from the NPN.

15. The computing system of claim 6, wherein the instructions further configure the system to:
receive a request for NPN access information by the content provider, the request for the NPN access information is associated with a user acquiring access to an event at a location that is within the location requirements, the request originating from a user associated with a subscription to access services of the h-PLMN, wherein the sending the network info for the NPN is responsive to receiving the request.

16. The computing system of claim 6, wherein the instructions further configure the system to:
after receiving the network info for the NPN by the h-PLMN, configure the UE to report location updates to an access function of the h-PLMN so that the access function can monitor when the UE meetings the time and location requirements for joining the NPN;
configure the access function of the h-PLMN to register location updates of the UE;
send a notification to the UE inviting a user associated with the UE to register for an event to gain access to the NPN;
determine that the UE has a context meeting the time and location requirements by the access function of the h-PLMN;
by an access mobility function of the h-PLMN.

17. A non-transitory computer-readable storage medium, the computer-readable storage medium including instructions that when executed by a computer, cause the computer to:
receive by a UE and from a home public land mobile network (h-PLMN), a steering of roaming update providing a steering of roaming record, wherein the UE is configured based on the steering of roaming record to connect to a non-public network (NPN) when a context of the UE meets time and location requirements; and
establish a session with the NPN when the context of the UE meets the time and location requirements.

18. The computer-readable storage medium of claim 17, wherein, the steering of roaming update configures the UE with time specific data for the time requirements and location specific data for the location requirement, wherein the UE can discover and select the NPN based on the time specific data and the location specific data.

19. The computer-readable storage medium of claim 6, wherein the instructions further configure the computer to:
receive a request for NPN access information by the content provider, the request for the NPN access information is associated with a user acquiring access to an event at a location that is within the location requirements, the request originating from a user associated with a subscription to access services of the h-PLMN, wherein the sending the network info for the NPN is responsive to receiving the request.

20. The computer-readable storage medium of claim 6, wherein the instructions further configure the computer to:
after receiving the network info for the NPN by the h-PLMN, configure the UE to report location updates to an access function of the h-PLMN so that the access function can monitor when the UE meetings the time and location requirements for joining the NPN;
configure the access function of the h-PLMN to register location updates of the UE;
send a notification to the UE inviting a user associated with the UE to register for an event to gain access to the NPN;
determine that the UE has a context meeting the time and location requirements by the access function of the h-PLMN;
by an access mobility function of the h-PLMN.
